(19) United States
(12) Patent Application Publication
(10) Pub. No.: US 2026/0359845 A1
(43) Pub. Date: Nov. 12, 2026

(54) SYSTEM, METHOD, AND COMPUTER PROGRAM PRODUCT FOR INTELLIGENT BUYER-SUPPLIER MATCHING AND MARKETPLACE OPTIMIZATION

(71) Applicant: BILL Operations, LLC, San Jose, CA (US)

(72) Inventors: Rachel Hoppe, Santa Clara, CA (US); Henrique Ceribelli, San Jose, CA (US); Ben De Rienzo, Shingle Springs, CA (US); Max Stepin, Redmond, WA (US); Venus So, San Mateo, CA (US); Ken Moss, Menlo Park, CA (US)

(21) Appl. No.: 19/200,510

(22) Filed: May 6, 2025

(51) Int. Cl. G06Q 30/0202; G06Q 10/0635; G06Q 10/087; G06Q 30/018; G06Q 30/0201; G06Q 30/0601

(52) U.S. Cl. CPC G06Q 30/0202; G06Q 10/0635; G06Q 10/087; G06Q 30/018; G06Q 30/0206; G06Q 30/0609; G06Q 30/06314

(57) ABSTRACT

System, method, and computer program product for intelligent buyer-supplier matching and marketplace optimization are disclosed herein. In use, comprehensive behavioral data for a plurality of buyers and suppliers is stored in a database. The stored behavioral data is analyzed using an AI model to generate buyer and supplier intelligence. A payment intelligence engine is integrated with the AI model to enhance decision-making and risk assessment. Intelligent matching recommendations between buyers and suppliers are provided based on: 1) the generated buyer and supplier intelligence and 2) data from the payment intelligence engine. An independent vendor-buyer hub is provided that is configured to display the intelligent matching recommendations and enable direct interactions and transactions. New behavioral data is collected based on at least one interaction or transaction of the independent vendor-buyer hub. The database is continuously updated and the AI model's predictive capabilities are refined based on the new behavioral data.

### FIELD OF THE INVENTION

The present disclosure relates to marketplace systems, and more particularly to an intelligent buyer-supplier matching and marketplace optimization system.

### BACKGROUND

The field of business-to-business (B2B) transactions faces a significant challenge in efficiently connecting buyers with suitable suppliers while optimizing marketplace interactions. This issue has become increasingly important due to the growing complexity of supply chains, the vast number of potential business partners, and the need for more streamlined procurement processes in today's fast-paced business environment.

Existing systems attempting to address this problem encounter several obstacles. These include limited access to comprehensive data about buyer and supplier behaviors, difficulties in accurately assessing the reliability and trustworthiness of potential business partners, and the inability to provide personalized recommendations based on a company's specific needs and transaction history. Additionally, many current platforms struggle to adapt quickly to changing market conditions and user preferences, which can lead to suboptimal matching and missed opportunities for both buyers and suppliers.

For instance, in scenarios where a buyer needs to quickly find a new supplier due to supply chain disruptions, current solutions often fail to provide timely and accurate recommendations that take into account factors such as the supplier's capacity, financial stability, and past performance. Another example is in the realm of pricing optimization, where existing methods are frequently unable to offer dynamic, data-driven insights that could help suppliers adjust their pricing strategies to remain competitive while maximizing profitability. These shortcomings highlight the need for more sophisticated, AI-driven approaches to B2B marketplace optimization that can leverage comprehensive data and adaptive learning capabilities to enhance the overall efficiency and effectiveness of buyer-supplier interactions.

As such, there is thus a need for addressing these and/or other issues associated with the prior art.

### SUMMARY

In some aspects, the techniques described herein relate to a computer program product for facilitating AI-driven buyer-supplier matching and marketplace optimization, the computer program product including a computer readable storage medium having program instructions embodied therewith, the program instructions executable by a processor to cause the processor to: store comprehensive behavioral data for a plurality of buyers and suppliers in a database; analyze the stored behavioral data, using an AI model, to generate buyer and supplier intelligence; integrate a payment intelligence engine with the AI model to enhance decision-making and risk assessment; provide intelligent matching recommendations between buyers and suppliers based on: 1) the generated buyer and supplier intelligence and 2) data from the payment intelligence engine; provide an independent vendor-buyer hub that is configured to display the intelligent display the intelligent matching recommendations and provide direct interactions and transactions; collect new behavioral data based on at least one interaction or transaction of the independent vendor-buyer hub; and continuously update the database and refine the AI model's predictive capabilities based on the new behavioral data.

In some aspects, the techniques described herein relate to a computer program product, wherein the comprehensive behavioral data includes transactional history, risk profiling data, and financial behavior data across multiple product offerings.

In some aspects, the techniques described herein relate to a computer program product, wherein the program instructions are further executable by the processor to cause the processor to: generate trust ratings for buyers and suppliers based on their behavioral data and transaction history; and incorporate the trust ratings into the matching recommendations provided by the AI model.

In some aspects, the techniques described herein relate to a computer program product, wherein the program instructions are further executable by the processor to cause the processor to flag entities with trust ratings below a predetermined threshold for further review or exclusion from matching recommendations.

In some aspects, the techniques described herein relate to a computer program product, wherein the AI model includes: a machine learning algorithm that continuously learns from user interactions; a natural language processing component for analyzing textual data in user profiles and communications; and a predictive analytics module for forecasting future buyer needs and supplier capabilities.

In some aspects, the techniques described herein relate to a computer program product, wherein the program instructions are further executable by the processor to cause the processor to utilize collaborative filtering techniques to identify non-obvious product connections and expand the range of relevant recommendations.

In some aspects, the techniques described herein relate to a computer program product, wherein the independent vendor-buyer hub includes: a secure communication channel for direct buyer-supplier negotiations; a smart contract system for automating agreement terms and conditions; and a dispute resolution mechanism integrated with the AI model for suggesting fair resolutions based on historical data and transaction patterns.

In some aspects, the techniques described herein relate to a computer program product, wherein the program instructions are further executable by the processor to cause the processor to provide a decentralized and tamper-resistant record of transactions and agreements within the vendor-buyer hub.

In some aspects, the techniques described herein relate to a computer program product, wherein the payment intelligence engine is configured to: analyze payment patterns, credit utilization, and cash flow cycles; generate risk assessments for buyers and suppliers; and provide tailored financial recommendations based on the analyzed data.

In some aspects, the techniques described herein relate to a computer program product, wherein the program instructions are further executable by the processor to cause the processor to integrate real-time market data and economic indicators into the payment intelligence engine to enhance the accuracy of financial recommendations and risk assessments.

In some aspects, the techniques described herein relate to a computer program product, wherein the program instructions are further executable by the processor to cause the processor to implement a dynamic supplier capacity modeling system that estimates supplier capacity based on historical transaction data, seasonal trends, and real-time order volumes.

In some aspects, the techniques described herein relate to a computer program product, wherein the program instructions are further executable by the processor to cause the processor to utilize the dynamic supplier capacity modeling system to provide buyers with real-time availability information and lead time estimates for potential suppliers.

In some aspects, the techniques described herein relate to a computer program product, wherein the program instructions are further executable by the processor to cause the processor to generate and implement an adaptive pricing algorithm that considers factors including supply chain disruptions, raw material costs, and competitor pricing to suggest optimal pricing strategies for suppliers.

In some aspects, the techniques described herein relate to a computer program product, wherein the program instructions are further executable by the processor to cause the processor to provide buyers with price trend forecasts and optimal purchase timing recommendations based on the adaptive pricing algorithm and historical transaction data.

In some aspects, the techniques described herein relate to a computer program product, wherein the program instructions are further executable by the processor to cause the processor to implement a cross-product recommendation system that analyzes buyer behavior across multiple product categories to suggest complementary or alternative products from different suppliers.

In some aspects, the techniques described herein relate to a computer program product, wherein the program instructions are further executable by the processor to cause the processor to utilize the cross-product recommendation system to identify potential bundling opportunities and suggest optimized product packages to both buyers and suppliers.

In some aspects, the techniques described herein relate to a computer program product, wherein the program instructions are further executable by the processor to cause the processor to integrate Internet of Things (IoT) devices to provide real-time data on inventory levels, production capacities, and logistics information, enhancing the accuracy of supplier information and matching recommendations.

In some aspects, the techniques described herein relate to a computer program product, wherein the program instructions are further executable by the processor to cause the processor to implement edge computing capabilities to process time-sensitive data from IoT devices locally, reducing latency and improving response times for real-time bidding and instant messaging between buyers and suppliers.

### BRIEF DESCRIPTION OF THE DRAWINGS

FIG. 1 illustrates a flowchart of a method for facilitating buyer-supplier matching and marketplace optimization, according to aspects of the present disclosure.

FIG. 2 illustrates a block diagram of an AI buyer-supplier matching and marketplace optimization system, in accordance with example embodiments.

FIG. 3 illustrates a flowchart of another method for facilitating buyer-supplier matching and marketplace optimization, according to an embodiment.

FIG. 4 illustrates a flowchart of a method for generating and utilizing trust ratings in a marketplace system, according to aspects of the present disclosure.

FIG. 5 illustrates a flowchart of a method for marketplace optimization, in accordance with example embodiments.

FIG. 6 illustrates a flowchart of a method for buyer-supplier matching and recommendation optimization, according to an aspect of the present disclosure.

FIG. 7 illustrates a block diagram of a marketplace system, according to an embodiment.

FIG. 8 illustrates a block diagram of a payment intelligence system, in accordance with example embodiments.

FIG. 9 illustrates a network system for facilitating communication between various devices, according to aspects of the present disclosure.

FIG. 10 illustrates a block diagram of a computing system, according to an embodiment.

### DETAILED DESCRIPTION

The present disclosure relates to the field of artificial intelligence-driven marketplace systems, specifically focusing on intelligent buyer-supplier matching and marketplace optimization. This technology aims to revolutionize business-to-business (B2B) transactions by leveraging comprehensive data analysis and adaptive learning capabilities to enhance the efficiency and effectiveness of buyer-supplier interactions.

Current B2B marketplace systems face significant challenges in efficiently connecting buyers with suitable suppliers while optimizing marketplace interactions. These challenges include limited access to comprehensive data about buyer and supplier behaviors, difficulties in accurately assessing the reliability and trustworthiness of potential business partners, and the inability to provide personalized recommendations based on a company's specific needs and transaction history. Additionally, many existing platforms struggle to adapt quickly to changing market conditions and user preferences, leading to suboptimal matching and missed opportunities for both buyers and suppliers.

The present disclosure addresses these challenges by introducing an innovative system that utilizes a comprehensive database of buyer and supplier behaviors, including transactional history, risk profiling, and financial behavior across multiple products. This system employs an AI model that continuously learns from user interactions to refine its predictive capabilities over time, providing intelligent matching and recommendations between buyers and suppliers based on extensive behavioral data. Furthermore, the system incorporates a Payment Intelligence Engine to enhance decision-making and risk assessment, while also establishing an independent vendor-buyer Hub for connections and transactions, generating additional data to improve offerings.

Moreover, the present disclosure features a dynamic supplier capacity modeling system that estimates supplier capacity based on historical transaction data, seasonal trends, and real-time order volumes, helping buyers identify suppliers who are most likely to meet their needs at any given time. The system also includes an adaptive pricing algorithm that considers factors such as supply chain disruptions, raw material costs, and competitor pricing to suggest optimal pricing strategies for suppliers and help buyers identify the best times to make purchases. These features, combined with the system's ability to generate and utilize trust ratings for buyers and suppliers, create a comprehensive solution that addresses the complex needs of modern B2B marketplace interactions.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

Within the context of the present disclosure, “vendor-buyer hub” refers to an independent transaction platform. For example, in one embodiment, a vendor-buyer hub may establish a platform where vendors and buyers can connect, interact, and transact independently from main services.

### Descriptions of Exemplary Embodiments

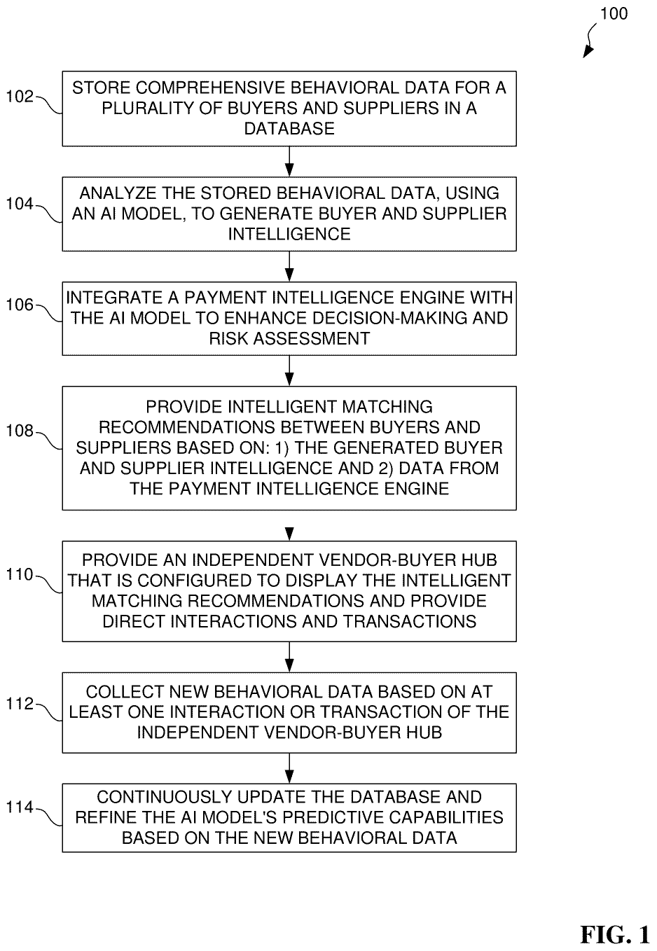

FIG. 1 illustrates a flowchart of a method 100 for facilitating buyer-supplier matching and marketplace optimization, in accordance with one embodiment. As an option, the method 100 may be implemented in the context of any one or more of the embodiments set forth in any previous and/or subsequent Figures and/or description thereof. Of course, however, the method 100 may be implemented in the context of any desired environment. Further, the aforementioned definitions may equally apply to the description below.

In step 102, comprehensive behavioral data is stored for a plurality of buyers and suppliers in a database is performed. The comprehensive behavioral data may include information related to procurement, purchasing, paying, and connecting behaviors of buyers and suppliers. This data may be collected from various sources, including transaction records, user interactions with the platform, and external market data. The database may utilize advanced data structures and indexing techniques to efficiently store and retrieve large volumes of behavioral data.

In some aspects, the comprehensive behavioral data may include payment-related information for both buyers and suppliers. For buyers, this data may encompass factors such as payment timeliness, payment amounts, and indicators of business growth trajectory. In the case of suppliers, the behavioral data may include metrics such as the number of users, trends in user acquisition, the volume of payments processed, and patterns in payment flow. Additionally, the supplier data may track the number of high-quality buyers associated with each supplier. It's worth noting that this list of behavioral data points is not exhaustive, and as the system evolves and more insights are gained, additional relevant metrics may be incorporated to enhance the accuracy and effectiveness of the AI-driven matching and optimization processes.

Further, the comprehensive behavioral data may include various aspects of buyer and supplier activities. For buyers, this data may encompass transaction history, a list of suppliers they have engaged with, items and services purchased, preferred payment methods, creditworthiness indicators, geographical location, and industry classification. In the case of suppliers, the behavioral data may include information on items and services offered, transaction volume and frequency, payment terms provided, risk profile assessments, geographical location, and preferences for receiving payments. These data points may provide a multifaceted view of both buyers and suppliers, potentially enabling more accurate matching and risk assessment. However, it's important to note that this list is not exhaustive, and additional relevant data points may be incorporated as the system evolves and new insights are gained.

In some cases, the procurement behavior data may include details such as frequency of purchases, preferred product categories, and supplier selection criteria. The purchasing behavior data may encompass information on order sizes, payment terms, and negotiation patterns. Additionally, the data may capture seasonal buying trends, responses to promotional offers, and historical supplier performance metrics. This comprehensive approach to data collection enables a more nuanced understanding of buyer and supplier behaviors across different market conditions.

In step 104, the stored behavioral data is analyzed using an AI model to generate buyer and supplier intelligence is executed. The AI model may utilize machine learning algorithms to identify patterns and trends in the behavioral data. These algorithms may include deep learning neural networks, decision trees, and clustering techniques to extract meaningful insights from complex datasets. The model may also employ natural language processing to analyze unstructured data from communication logs and user feedback. In one embodiment, the AI model may be adaptive. For example, the AI model may continuously learn and refine its predictive capabilities based on new data generated through user interactions, transactions, and marketplace dynamics. This ongoing adaptation may allow the model to adjust its algorithms and weightings in real-time, potentially improving the accuracy of buyer-supplier matching recommendations and market insights as the system processes more information over time.

The generated buyer intelligence may include insights into purchasing preferences, budget constraints, and supplier requirements. Similarly, the supplier intelligence may encompass information on production capacity, pricing strategies, and customer service quality. The AI model may also generate predictive insights, such as forecasting future buying patterns or identifying potential supply chain disruptions. These advanced analytics capabilities enable the system to provide more accurate and actionable intelligence to both buyers and suppliers.

In step 106, a payment intelligence engine is integrated with the AI model to enhance decision-making and risk assessment is performed. The payment intelligence engine may analyze historical payment data to evaluate the financial reliability of buyers and suppliers. This engine may incorporate advanced financial modeling techniques, such as time series analysis and Monte Carlo simulations, to assess credit risk and predict future payment behaviors.

This integration may enable the system to provide more accurate risk assessments and credit recommendations. Additionally, the payment intelligence engine may help identify potential cash flow issues or payment delays before they occur. The engine may also analyze macroeconomic indicators and industry-specific financial trends to provide context-aware risk assessments. This comprehensive approach to financial intelligence allows for more informed decision-making in buyer-supplier relationships.

In step 108, intelligent matching recommendations are provided between buyers and suppliers based on the generated buyer and supplier intelligence and data from the payment intelligence engine is executed. These recommendations may take into account factors such as product compatibility, pricing alignment, and risk profiles. The matching algorithm may also consider factors like geographical proximity, sustainability practices, and compliance with industry-specific regulations to ensure comprehensive compatibility.

In various embodiments, the recommendation algorithms may generally align with observed trends in the marketplace. For instance, suppliers that demonstrate broad usage, consistent growth, and favorable quality-to-price ratios may tend to receive higher priority in the recommendations. It's worth noting that the algorithms are designed to operate without inherent biases, focusing instead on objective metrics and performance indicators. This approach may help ensure that recommendations are based on actual marketplace dynamics and supplier performance rather than predetermined preferences or arbitrary factors. However, the specific weighting and importance of various factors in the recommendation process may evolve as the system gathers more data and refines its understanding of successful buyer-supplier matches.

The matching recommendations may be presented through a user interface that allows buyers and suppliers to review potential matches. In some cases, the system may provide a compatibility score or ranking to help users evaluate the suitability of potential business partners. The interface may also offer interactive features, such as side-by-side comparisons of potential matches and the ability to adjust matching criteria in real-time. This user-centric approach to presenting recommendations enhances the decision-making process for both buyers and suppliers.

In step 110, an independent vendor-buyer hub is provided configured to display the intelligent matching recommendations and provide direct interactions and transactions. This hub may serve as a centralized platform for buyers and suppliers to connect and conduct business. The hub may feature a customizable dashboard that allows users to tailor their experience based on their specific needs and preferences.

The vendor-buyer hub may offer features such as secure messaging, document sharing, and transaction processing. These features may facilitate seamless communication and collaboration between matched buyers and suppliers. The hub may also incorporate advanced security measures, such as multi-factor authentication and encryption, to protect sensitive business information. Additionally, the hub may offer integration capabilities with popular enterprise resource planning (ERP) systems to streamline workflow processes for users.

In step 112, new behavioral data is collected based on interactions or transactions executing through the independent vendor-buyer hub. This data collection process may be continuous and may capture various aspects of user behavior within the hub. The system may employ advanced tracking mechanisms to capture detailed interaction data, such as time spent reviewing recommendations, frequency of communication between parties, and patterns in negotiation processes.

The collected data may include information on negotiation processes, contract terms, and transaction outcomes. This rich dataset may provide valuable insights into the effectiveness of the matching recommendations and the overall user experience. The system may also collect feedback data through surveys and user ratings to gather qualitative insights on the platform's performance. This comprehensive data collection approach enables a more holistic understanding of user behavior and platform effectiveness.

In step 114, the database is updated and the AI model's predictive capabilities are refined based on the new behavioral data. This step creates a continuous feedback loop that allows the system to learn and improve over time. The updating process may involve sophisticated data integration techniques to ensure that new data is properly contextualized and incorporated into existing datasets.

In various embodiments, the system's predictive capabilities may be evaluated and refined based on several key performance indicators. In particular, match rates (the frequency at which recommended connections are established) and connect rates (the proportion of successful ongoing relationships) may serve as primary metrics for assessing the effectiveness of the AI model's recommendations. Additionally, the resulting Total Payment Volume (TPV) flowing through these established connections may be considered as an ultimate measure of the system's ability to facilitate valuable, long-term business relationships. These metrics may provide insights into both the immediate success of matches and their long-term economic impact, potentially allowing the system to continuously improve its predictive accuracy and the overall value it delivers to users. However, the specific weighting and interpretation of these metrics may evolve as the system gathers more data and gains deeper insights into the factors that contribute to successful buyer-supplier relationships.

The refinement of the AI model may involve adjusting weightings of various factors, incorporating new variables, or modifying prediction algorithms. This ongoing optimization process may help ensure that the system remains effective and relevant as market conditions and user behaviors evolve. The AI model may employ techniques such as transfer learning and reinforcement learning to adapt quickly to new patterns and trends in the data. Additionally, the system may periodically perform comprehensive model evaluations to identify areas for improvement and ensure the ongoing accuracy of its predictions.

The system's adaptive capabilities may allow it to respond to various market changes and disruptions by closely monitoring and analyzing the behaviors of buyers and suppliers within the marketplace. For instance, in the event of sudden market shifts, such as supply chain disruptions or economic downturns, the system may detect emerging patterns in user interactions and transaction data. One way the system might adapt is by observing changes in buyer engagement patterns. If a particular supplier begins to receive increased attention or transactions from multiple buyers, the recommendation system may adjust its algorithms to give that supplier higher priority in its recommendations. This approach may help the system quickly identify and promote suppliers who are effectively meeting market demands during challenging periods. However, the specific mechanisms for adaptation may vary and evolve as the system encounters different types of market changes and gathers more data on effective responses to various disruptions.

The method 100 demonstrates a resolution to challenges faced by traditional B2B marketplace systems, which often struggle to provide accurate and personalized matching recommendations. By leveraging comprehensive behavioral data and adaptive AI technology, the method 100 offers a more sophisticated approach to buyer-supplier matching. Furthermore, the integration of a payment intelligence engine addresses the common issue of assessing financial risk in B2B transactions. This feature may help reduce the likelihood of payment defaults or supply chain disruptions, thereby increasing trust and efficiency in the marketplace.

In various embodiments, the AI-driven matching system may be particularly effective in industries or market sectors characterized by high volumes of data, including numerous suppliers, buyers, and transactions. These data-rich environments may provide ample opportunities for the system to discover patterns, identify anomalies, and generate insightful recommendations. In sectors with complex supply chains, diverse product offerings, or frequent transactions, the system's ability to analyze comprehensive behavioral data and adapt to changing market conditions may offer significant advantages. However, the effectiveness of the system may not be limited to specific industries, as its adaptive nature allows it to potentially learn and optimize its performance across various market contexts. The system's ability to tailor its approach based on the unique characteristics and dynamics of different sectors may contribute to its versatility and potential applicability across a wide range of B2B marketplace scenarios.

In various embodiments, the method 100 may be extended to include additional data sources for enhancing buyer and supplier intelligence. For example, the system may incorporate external market data, industry trends, or economic indicators to provide more contextual recommendations. Additionally, the method 100 may be adapted to support specific industry verticals by incorporating sector-specific data and matching criteria. This specialization may allow for more nuanced and relevant recommendations in industries with unique requirements or regulations. Further, the method 100 may be enhanced to include predictive analytics capabilities. These capabilities may enable the system to forecast future market trends, anticipate changes in buyer or supplier behavior, and proactively suggest business opportunities to users.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

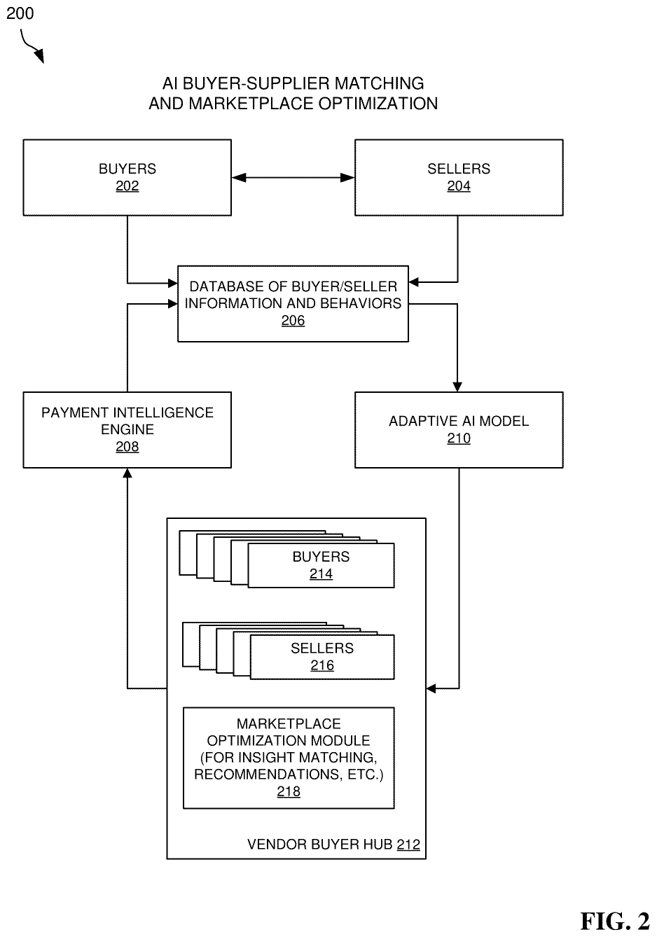

FIG. 2 illustrates a block diagram of an AI buyer-supplier matching and marketplace optimization system 200, in accordance with one embodiment. As an option, the AI buyer-supplier matching and marketplace optimization system 200 may be implemented in the context of any one or more of the embodiments set forth in any previous and/or subsequent Figures and/or description thereof. Of course, however, the AI buyer-supplier matching and marketplace optimization system 200 may be implemented in the context of any desired environment. Further, the aforementioned definitions may equally apply to the description below.

The AI buyer-supplier matching and marketplace optimization system 200 includes a buyer module 202 and a seller module 204 that interface with an information database 206. The information database 206 may store comprehensive data related to buyers and sellers, including transactional history, risk profiles, and financial behavior across multiple product offerings. This database may utilize advanced data structures and indexing techniques to efficiently store and retrieve large volumes of behavioral data.

In some cases, the buyer module 202 may collect and process data specific to buyers, such as purchasing patterns, product preferences, and budget constraints. The seller module 204 may similarly gather and analyze information related to suppliers, including production capacity, pricing strategies, and customer service metrics. Both modules may employ machine learning algorithms to identify trends and anomalies in user behavior, providing deeper insights into buyer needs and supplier capabilities. Additionally, these modules may integrate with external data sources to enrich their analyses with market trends and industry benchmarks.

The AI buyer-supplier matching and marketplace optimization system 200 also comprises a payment intelligence module 208 and an adaptive model 210. The adaptive model 210 may receive data from the information database 206 to analyze buyer and seller information, generating insights and predictions to facilitate optimal matching. This model may utilize ensemble learning techniques, combining multiple algorithms to improve overall prediction accuracy. It may also employ transfer learning to apply knowledge gained from one market sector to enhance predictions in related sectors with limited data.

The payment intelligence module 208 may analyze payment patterns, credit utilization, and cash flow cycles to enhance decision-making and risk assessment within the system. This module may provide valuable financial intelligence to support the matching process and marketplace optimization. It may also integrate with external credit rating agencies and financial institutions to gather comprehensive financial data on buyers and suppliers. The module may use advanced statistical techniques and machine learning algorithms to detect anomalies in payment behaviors that could indicate potential financial distress or fraud.

A vendor buyer hub 212 is included within the AI buyer-supplier matching and marketplace optimization system 200, maintaining bidirectional communication with both the information database 206 and external users. The vendor buyer hub 212 may serve as a centralized platform for buyers and suppliers to connect, interact, and conduct transactions. This hub may feature a multi-lingual interface and real-time translation capabilities to facilitate international transactions. It may also incorporate augmented reality features to allow buyers to virtually inspect products or tour supplier facilities, enhancing the remote evaluation process.

The independent vendor-buyer hub may offer unique features that set it apart from existing B2B marketplace platforms, at least in part due to its integration with the comprehensive data analysis capabilities of the system. One of the key differentiators may be the hub's ability to provide insights derived from the extensive behavioral and transactional data collected across the platform. These insights, which may not be available on other marketplaces, could potentially offer users a deeper understanding of market trends, buyer preferences, and supplier performance. The hub may leverage this data to provide personalized recommendations, risk assessments, and market intelligence that go beyond simple matching services. Additionally, the hub's real-time adaptation to user interactions and market changes may allow it to offer more dynamic and relevant services compared to traditional platforms. However, the specific features and capabilities of the hub may continue to evolve as the system gathers more data and refines its understanding of user needs and market dynamics.

The vendor buyer hub 212 comprises multiple components, including a buyer data store 214 and a seller data store 216 for maintaining buyer and seller information respectively. These data stores may contain detailed profiles, transaction histories, and preference settings for each user within the system. They may implement advanced data compression and indexing techniques to efficiently store and retrieve large volumes of user data. These stores may also use differential privacy techniques to allow for data analysis while protecting individual user privacy and complying with data protection regulations.

A marketplace optimization module 218 is also included within the vendor buyer hub 212, providing intelligent matching and recommendations functionality. The marketplace optimization module 218 may leverage the insights generated by the adaptive model 210 to suggest optimal buyer-supplier pairings and business opportunities. This module may utilize reinforcement learning algorithms to continuously refine its matching strategies based on the outcomes of previous recommendations. It may also incorporate game theory principles to optimize negotiation strategies and suggest mutually beneficial terms for buyers and suppliers.

The adaptive model 210 may include a natural language processing component for analyzing textual data in user profiles and communications. This component may enable the system to extract meaningful information from unstructured text, enhancing the accuracy of user profiling and matching recommendations. The natural language processing component may employ advanced semantic analysis and sentiment analysis techniques to understand context, nuances, and emotional tones in user communications, allowing for more accurate interpretation of requirements and preferences.

In some cases, the adaptive model 210 may incorporate a predictive analytics module for forecasting future buyer needs and supplier capabilities. This module may analyze historical data and market trends to anticipate upcoming demand patterns and supply chain dynamics, allowing for proactive matchmaking and business planning. The predictive analytics module may integrate external data sources such as economic indicators, weather patterns, and geopolitical events to enhance its forecasting capabilities. It may use Monte Carlo simulations and other advanced statistical methods to model various scenarios and provide probabilistic forecasts of market conditions.

The adaptive model 210 may also feature a machine learning algorithm that continuously learns from user interactions. As buyers and suppliers engage with the system, their behaviors and outcomes may be used to refine the model's predictive capabilities, ensuring that recommendations become increasingly accurate and relevant over time. This algorithm may implement federated learning techniques, allowing the model to learn from decentralized data sources without compromising user privacy. This approach may enable the system to leverage insights from a wider range of transactions while maintaining data confidentiality and compliance with data protection regulations.

In some cases, the system 200 may be adapted to support specific industry verticals by incorporating sector-specific data and matching criteria. This specialization may allow for more nuanced and relevant recommendations in industries with unique requirements or regulations. Additionally, the AI buyer-supplier matching and marketplace optimization system 200 may be enhanced to include advanced visualization tools for presenting complex data relationships and market trends to users. These tools may help buyers and suppliers make more informed decisions by providing clear, actionable insights derived from the system's comprehensive data analysis and predictive modeling capabilities.

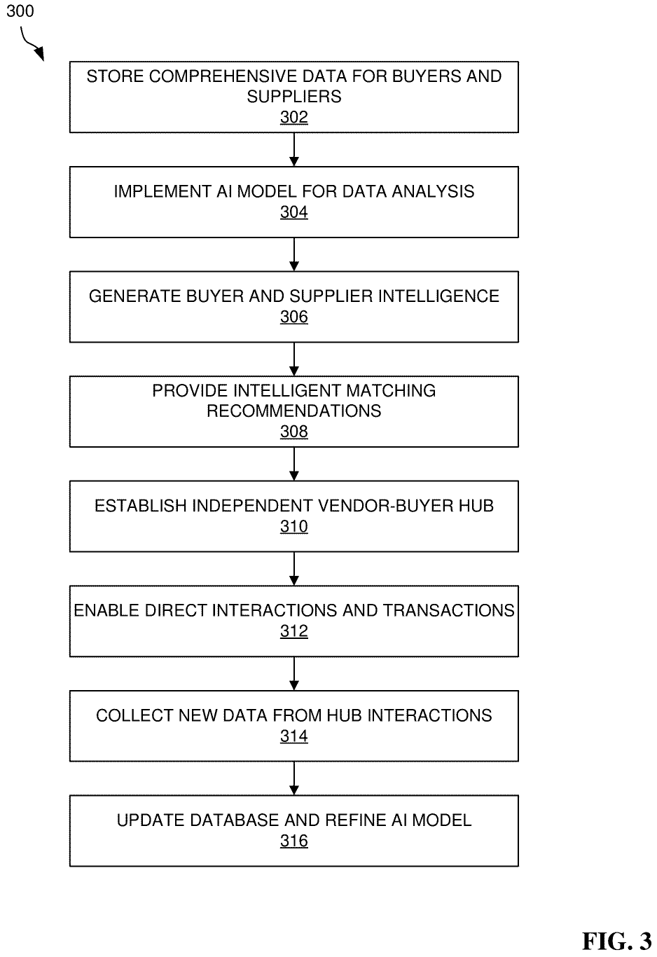

FIG. 3 illustrates a flowchart of a method 300 for facilitating buyer-supplier matching and marketplace optimization, in accordance with one embodiment. As an option, the method 300 may be implemented in the context of any one or more of the embodiments set forth in any previous and/or subsequent Figures and/or description thereof. Of course, however, the method 300 may be implemented in the context of any desired environment. Further, the aforementioned definitions may equally apply to the description below.

In step 302, comprehensive data is stored for buyers and suppliers in a database is performed. The comprehensive data may include transactional history, risk profiles, and financial behavior across multiple product offerings. This data may also encompass detailed information on product specifications, pricing structures, delivery performance, and customer satisfaction metrics. The database may utilize advanced encryption techniques to ensure data security and compliance with privacy regulations.

In some cases, the database may be similar to the information database 206 described in FIG. 2. The comprehensive data may be collected through various sources, including the buyer module 202 and seller module 204, to ensure a holistic view of both buyers and suppliers. Additional data sources may include external market research reports, industry benchmarks, and real-time economic indicators to provide broader context for buyer-supplier relationships.

In step 304, an AI model is implemented for analyzing the stored data is executed. The AI model may utilize machine learning algorithms to process and interpret the comprehensive data stored in the database. These algorithms may include deep learning neural networks, decision trees, and ensemble methods to extract complex patterns and relationships from the data.

The AI model may be similar to the AI model 210 described in FIG. 2. In some cases, the AI model may incorporate natural language processing capabilities to analyze textual data from user profiles and communications. This may include sentiment analysis of customer reviews, interpretation of contract terms, and extraction of key information from unstructured communication logs.

In step 306, buyer and supplier intelligence is generated based on the analysis is performed. This intelligence may include insights into purchasing patterns, supplier capabilities, risk assessments, and market trends. The intelligence may also provide predictive analytics on future demand, potential supply chain disruptions, and emerging market opportunities.

The generated intelligence may be used by the marketplace optimization module 218 to improve matching recommendations and overall marketplace efficiency. In some cases, the intelligence may also be made available to users through the vendor buyer hub 212 to support informed decision-making. This may include customized dashboards and reports tailored to specific user roles and preferences.

In step 308, intelligent matching recommendations are provided between buyers and suppliers using the generated intelligence is executed. These recommendations may take into account factors such as product compatibility, pricing alignment, and risk profiles. The system may also consider factors like geographical proximity, sustainability practices, and compliance with industry-specific regulations to ensure comprehensive compatibility.

The matching recommendations may be presented through a user interface within the vendor buyer hub 212. In some cases, the system may provide a compatibility score or ranking to help users evaluate the suitability of potential business partners. The interface may also offer interactive features such as side-by-side comparisons of potential matches and the ability to adjust matching criteria in real-time.

In step 310, an independent vendor-buyer hub is established. This hub may serve as a centralized platform for buyers and suppliers to connect and conduct business. The hub may feature a customizable dashboard that allows users to tailor their experience based on their specific needs and preferences.

The independent vendor-buyer hub may be similar to the vendor buyer hub 212 described in FIG. 2. It may offer features such as secure messaging, document sharing, and transaction processing to facilitate seamless communication and collaboration between matched buyers and suppliers. The hub may also incorporate advanced security measures, such as multi-factor authentication transaction verification, to ensure trust and transparency in all interactions.

In step 312, direct interactions and transactions are enabled between buyers and suppliers through the hub is executed. This step allows users to engage in business activities within a secure and controlled environment. The hub may provide tools for virtual meetings, product demonstrations, and collaborative project management to enhance the interaction experience.

The hub may provide tools for negotiation, contract management, and order processing. In some cases, the payment intelligence module 208 may be integrated into the hub to provide real-time financial insights and risk assessments during transactions. This may include automated credit checks, dynamic pricing recommendations, and instant payment processing options to streamline the transaction process.

In step 314, new data is collected from hub interactions between buyers and suppliers is performed. This data collection process may be continuous and may capture various aspects of user behavior within the hub. The system may employ advanced tracking mechanisms to capture detailed interaction data, such as time spent reviewing recommendations, frequency of communication between parties, and patterns in negotiation processes.

The collected data may include information on negotiation processes, contract terms, and transaction outcomes. This rich dataset may provide valuable insights into the effectiveness of the matching recommendations and the overall user experience. The system may also collect feedback data through surveys and user ratings to gather qualitative insights on the platform's performance.

In step 316, the database is updated and the AI model is refined based on the newly collected data is executed. This step creates a continuous feedback loop that allows the system to learn and improve over time. The updating process may involve sophisticated data integration techniques to ensure that new data is properly contextualized and incorporated into existing datasets.

The AI model may refine its predictive capabilities by using newer data for training and user acceptance/feedback to tune its algorithms. This ongoing optimization process may help ensure that the system remains effective and relevant as market conditions and user behaviors evolve. The AI model may employ techniques such as transfer learning and reinforcement learning to adapt quickly to new patterns and trends in the data. Additionally, the system may periodically perform comprehensive model evaluations to identify areas for improvement and ensure the ongoing accuracy of its predictions.

In various embodiments, the method 300 may be enhanced to include predictive analytics capabilities. These capabilities may enable the system to forecast future market trends, anticipate changes in buyer or supplier behavior, and proactively suggest business opportunities to users.

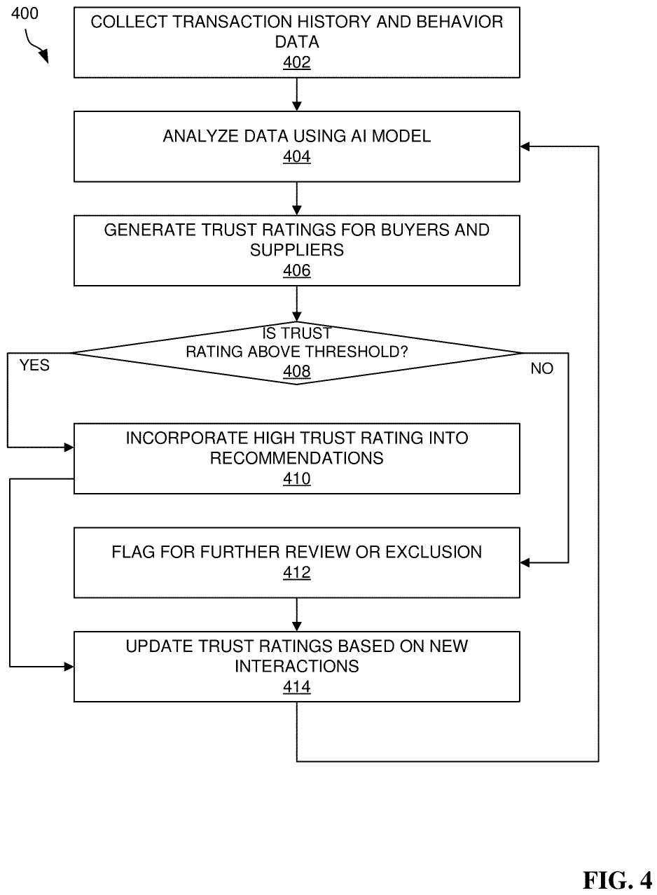

FIG. 4 illustrates a flowchart of a method 400 for generating and utilizing trust ratings in a marketplace system, in accordance with one embodiment. As an option, the method 400 may be implemented in the context of any one or more of the embodiments set forth in any previous and/or subsequent Figures and/or description thereof. Of course, however, the method 400 may be implemented in the context of any desired environment. Further, the aforementioned definitions may equally apply to the description below.

In step 402, transaction history and behavior data are collected. The transaction history and behavior data may be collected from various sources within the marketplace system, including the buyer module 202, seller module 204, and information database 206. This data collection process may also incorporate external sources such as credit bureaus, industry-specific databases, and public records to provide a more comprehensive view of user behavior. The system may employ advanced data mining techniques and natural language processing to extract relevant information from unstructured data sources, such as customer support logs and social media interactions.

In some cases, the transaction history may include details such as order fulfillment rates, payment timeliness, and dispute resolution outcomes. The behavior data may encompass aspects like communication responsiveness, negotiation patterns, and adherence to platform policies. Additionally, the system may track more nuanced behavioral indicators, such as the frequency of profile updates, engagement with platform educational resources, and participation in community forums or events. These additional data points may provide insights into a user's commitment to the platform and their overall professionalism.

In step 404, the collected data is analyzed using an AI model. The AI model may be part of the adaptive model 210 and may employ machine learning algorithms to process and interpret the collected data. The model may utilize a combination of supervised and unsupervised learning techniques, including deep neural networks, random forests, and clustering algorithms, to identify complex patterns and relationships within the data. The AI model may also incorporate transfer learning techniques to leverage insights gained from one market sector to improve analysis in related sectors.

The AI model may identify patterns and trends in the transaction history and behavior data, such as consistent late payments or frequent order cancellations. In some cases, the model may also consider contextual factors like industry norms or seasonal fluctuations when analyzing the data. The model may employ time series analysis to detect cyclical patterns and anomalies in user behavior, and may use sentiment analysis on communication data to gauge the overall health of buyer-supplier relationships. Furthermore, the model may incorporate external economic indicators and market trends to provide a more holistic analysis of user behavior within the broader business context.

In step 406, trust ratings are generated for buyers and suppliers based on the analyzed data is performed. The trust ratings may be numerical scores or categorical classifications that reflect the reliability and credibility of marketplace participants. The trust rating algorithm may employ a multi-dimensional approach, considering various aspects of user behavior and performance to create a comprehensive trust profile. This may include separate sub-scores for financial reliability, communication quality, product or service quality, and overall platform engagement.

The trust ratings may take into account various aspects of a user's experience within the marketplace, such as transaction completion rates, feedback from other users, and compliance with platform rules. In some cases, the ratings may be weighted based on the recency and significance of different data points. The system may also implement a dynamic weighting system that adjusts the importance of different factors based on the specific context of each transaction or interaction. For instance, timely delivery may be weighted more heavily for time-sensitive industries, while long-term relationship history might be prioritized for high-value, complex transactions.

In step 408, it is determined whether a trust rating is above a threshold is executed. This step may involve comparing the generated trust rating to a predetermined threshold value that represents a minimum acceptable level of trustworthiness. The system may employ multiple thresholds for different aspects of trustworthiness, allowing for a more nuanced evaluation of user reliability. For example, separate thresholds may exist for financial stability, stepal performance, and community engagement.

The threshold may be set by the marketplace system administrators and may vary depending on factors such as transaction value or industry sector. In some cases, different thresholds may be applied for buyers and suppliers to account for their distinct roles in the marketplace. The system may also implement adaptive thresholds that automatically adjust based on overall marketplace performance and risk levels. This dynamic approach ensures that trust standards evolve with the marketplace, maintaining an appropriate balance between accessibility and risk management.

If the trust rating is above the threshold (Yes branch), a step 410 of incorporating the high trust rating into recommendations is performed. The high trust rating may be used by the marketplace optimization module 218 to prioritize or highlight highly trustworthy users in matching recommendations. The system may employ advanced matching algorithms that balance trust ratings with other factors such as product fit, pricing, and delivery capabilities to generate optimal buyer-supplier pairings. These algorithms may use machine learning techniques to continuously refine the weighting of trust ratings in the matching process based on successful outcomes.

In some cases, users with high trust ratings may receive additional benefits within the marketplace, such as increased visibility in search results or access to premium features. The incorporation of trust ratings into recommendations may help foster a more reliable and efficient marketplace ecosystem. The system may also provide detailed trust score breakdowns to users, offering transparency and encouraging continuous improvement. Additionally, the marketplace may implement a tiered membership system based on trust ratings, offering escalating benefits and opportunities to users as they build and maintain high levels of trust.

If the trust rating is not above the threshold (No branch), a step 412 of flagging the entity for further review or exclusion is executed. This step may involve notifying marketplace administrators or triggering automated processes to investigate the flagged entity. The system may employ risk assessment algorithms to categorize flagged entities based on the severity and nature of their trust issues, prioritizing cases for review and determining appropriate intervention strategies.

The system may employ a data-driven approach to balance automated matching with potential human intervention. In cases where there is high confidence backed by substantial historical data, the system may rely more heavily on automated processes. However, when dealing with entities that fall below certain trust thresholds, the system may implement a nuanced approach. This could involve flagging entities for further review, which may trigger notifications to marketplace administrators or initiate automated investigation processes. The system may utilize risk assessment algorithms to categorize flagged entities based on various factors, such as the severity and nature of their trust issues. This categorization may help prioritize cases for review and guide the determination of appropriate intervention strategies. The level of human involvement in these processes may vary depending on the confidence level of the automated assessments and the complexity of the issues identified. As the system accumulates more data and refines its algorithms, it may potentially reduce the need for human intervention in routine cases while still allowing for manual oversight in more complex or ambiguous situations.

Entities flagged for review may be subject to additional verification procedures or temporary restrictions on their marketplace activities. In some cases, the system may provide guidance or support to help flagged entities improve their trust ratings over time. This may include personalized improvement plans, access to educational resources, or mentorship programs pairing struggling users with highly trusted marketplace participants. The system may also implement a probationary period for flagged entities, during which they receive closer monitoring and must meet specific performance targets to regain full marketplace privileges.

In step 414, trust ratings are updated based on new interactions is performed. This step ensures that trust ratings remain current and reflective of users' ongoing behavior within the marketplace. The updating process may involve a combination of real-time adjustments for significant events and periodic comprehensive reviews of user profiles. The system may employ machine learning algorithms to detect patterns of improvement or deterioration in user behavior, allowing for proactive interventions or rewards.

The updating process may involve recalculating trust ratings at regular intervals or in response to significant events, such as the completion of high-value transactions. In some cases, the system may employ a decay factor to give more weight to recent interactions while still considering historical data. The decay factor may be dynamically adjusted based on the user's overall history and the stability of their past performance. Additionally, the system may implement a challenge mechanism allowing users to request expedited trust rating reviews if they believe their recent performance merits a faster update. This feature encourages active engagement with the trust system and provides opportunities for rapid rehabilitation of trust scores.

Additionally, the method 400 may be enhanced to include a dispute resolution mechanism that takes into account trust ratings when mediating conflicts between buyers and suppliers. This integration may help streamline conflict resolution processes and incentivize positive behavior within the marketplace.

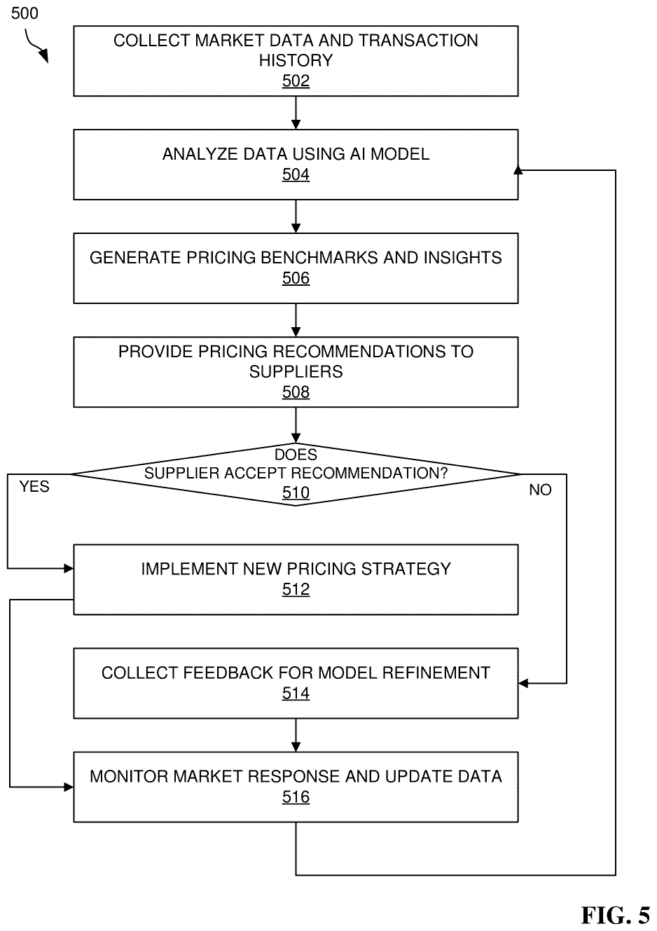

FIG. 5 illustrates a flowchart of a method 500 for marketplace optimization, in accordance with one embodiment. As an option, the method 500 may be implemented in the context of any one or more of the embodiments set forth in any previous and/or subsequent Figures and/or description thereof. Of course, however, the method 500 may be implemented in the context of any desired environment. Further, the aforementioned definitions may equally apply to the description below.

In step 502, collecting market data and transaction history are collected. The market data may include information on industry trends, competitor pricing, and supply chain dynamics. The transaction history may encompass details of past buyer-supplier interactions within the marketplace system. This data collection may also include macroeconomic indicators, regulatory changes affecting specific industries, and emerging technological disruptions that could impact market conditions. The system may employ web scraping techniques to gather real-time data from public sources and integrate it with proprietary market intelligence reports.

In some cases, the market data may be sourced from external databases or industry reports, while the transaction history may be extracted from the information database 206. The collection process may be continuous, ensuring that the system has access to the most up-to-date information for analysis. The system may utilize APIs to connect with various data providers, enabling automatic updates and reducing latency in data acquisition. Additionally, the system may implement data quality checks and validation processes to ensure the accuracy and reliability of the collected information.

In step 504, the collected data is analyzed using an AI model. The AI model may be part of the adaptive model 210 and may employ machine learning algorithms to process and interpret the collected market data and transaction history. The model may utilize advanced techniques such as deep learning neural networks, gradient boosting machines, and recurrent neural networks to capture complex temporal dependencies in the data. It may also incorporate natural language processing to analyze unstructured text data from market reports and news sources.

The analysis may involve identifying patterns in pricing strategies, evaluating the effectiveness of different negotiation tactics, and assessing the impact of market trends on buyer-supplier relationships. In some cases, the AI model may also consider factors such as seasonality or regional variations in its analysis. The model may employ time series decomposition techniques to isolate trend, seasonal, and cyclical components in the data, allowing for more nuanced predictions. It may also use anomaly detection algorithms to identify unusual market events or outlier transactions that could provide valuable insights.

In step 506, pricing benchmarks and insights are generated based on the analysis is performed. These benchmarks and insights may provide valuable guidance for suppliers in setting competitive and profitable pricing strategies. The system may utilize advanced statistical methods such as quantile regression to provide more robust benchmarks that account for the full distribution of prices in the market, not just average values. It may also employ Bayesian inference techniques to quantify uncertainty in the generated insights, providing confidence intervals for pricing recommendations.

The pricing benchmarks may include industry averages, optimal price points for different product categories, and price elasticity estimates. The insights may offer recommendations on when to adjust prices, how to structure volume discounts, or which product bundles may be most attractive to buyers. The system may also generate dynamic pricing models that adapt to real-time market conditions, considering factors such as inventory levels, competitor actions, and demand fluctuations. These models may incorporate game theory principles to optimize pricing strategies in competitive market scenarios.

In step 508, pricing recommendations are provided to suppliers. These recommendations may be tailored to each supplier's specific product offerings, target market, and historical performance within the marketplace. The system may utilize collaborative filtering techniques to identify similar suppliers and leverage their successful pricing strategies in generating recommendations. It may also employ multi-armed bandit algorithms to balance exploration of new pricing strategies with exploitation of known successful approaches.

The pricing recommendations may be presented through the vendor buyer hub 212, potentially as part of the marketplace optimization module 218. In some cases, the system may provide visualizations or simulations to help suppliers understand the potential impact of different pricing strategies. These visualizations may include interactive dashboards with scenario analysis tools, allowing suppliers to explore the potential outcomes of various pricing decisions. The system may also generate natural language summaries of the recommendations, explaining the rationale behind each suggestion in clear, actionable terms.

In decision 510, it is determined whether the supplier accepts the recommendation is performed. This decision point allows the system to adapt its approach based on supplier feedback and preferences. The system may implement a user-friendly interface for suppliers to easily accept, reject, or modify recommendations, potentially using a slider or dial mechanism to fine-tune suggested prices within a recommended range.

The acceptance or rejection of recommendations may be tracked by the system to refine future suggestions. In some cases, suppliers may have the option to provide reasons for their decision, which can be used to further improve the AI model's understanding of supplier decision-making processes. The system may employ sentiment analysis on the feedback provided to gauge supplier satisfaction and identify areas for improvement in the recommendation process. It may also use this feedback to adjust the weighting of different factors in its pricing models.

If the supplier accepts the recommendation (Yes branch from step 510), a step 512 of implementing a new pricing strategy is executed. This implementation may involve updating product listings, adjusting contract terms, or modifying promotional offers within the marketplace system. The system may provide automated tools to streamline the implementation process, such as bulk update features for large product catalogs or integration with popular e-commerce platforms.

The implementation process may be facilitated through the vendor buyer hub 212, potentially leveraging features of the seller module 204 to ensure smooth integration of the new pricing strategy into the supplier's existing steps. The system may also offer a staged implementation option, allowing suppliers to test new pricing strategies on a subset of products or in specific market segments before full rollout. Additionally, it may provide real-time monitoring tools to track the immediate impact of price changes on sales and buyer behavior.

If the supplies rejects the recommendation (No branch from step 510), a step 514 of collecting feedback for model refinement is performed. This feedback may include the supplier's decision, any explanations provided, and subsequent performance data related to the pricing strategy. The system may employ advanced natural language processing techniques to extract meaningful insights from unstructured feedback comments. It may also use reinforcement learning algorithms to continuously optimize its recommendation strategies based on the outcomes of implemented pricing changes.

The collected feedback may be used to update the adaptive model 210, potentially improving the accuracy and relevance of future pricing recommendations. In some cases, the system may also analyze patterns in supplier decisions to identify common factors influencing pricing strategy choices. The system may employ clustering algorithms to group suppliers with similar decision-making patterns, allowing for more targeted and relevant recommendations in the future. It may also generate periodic reports summarizing key learnings from the feedback process, providing valuable insights to both system developers and marketplace administrators.

In step 516, market response are monitored and data is updated. This step involves tracking how buyers react to the implemented pricing strategies and how these reactions impact overall marketplace dynamics. The system may utilize advanced analytics techniques such as cohort analysis to understand how different buyer segments respond to price changes over time. It may also employ predictive modeling to forecast the long-term effects of pricing strategies on market share and customer loyalty.

The monitoring process may involve analyzing changes in order volumes, buyer engagement metrics, or competitor responses. In some cases, the system may use this updated data to trigger new analyses or generate revised recommendations if significant market shifts are detected. The system may implement automated alerts to notify suppliers of sudden changes in market conditions or unexpected buyer responses to price changes. Additionally, it may use machine learning algorithms to identify leading indicators of market shifts, allowing for proactive adjustments to pricing strategies before major changes occur.

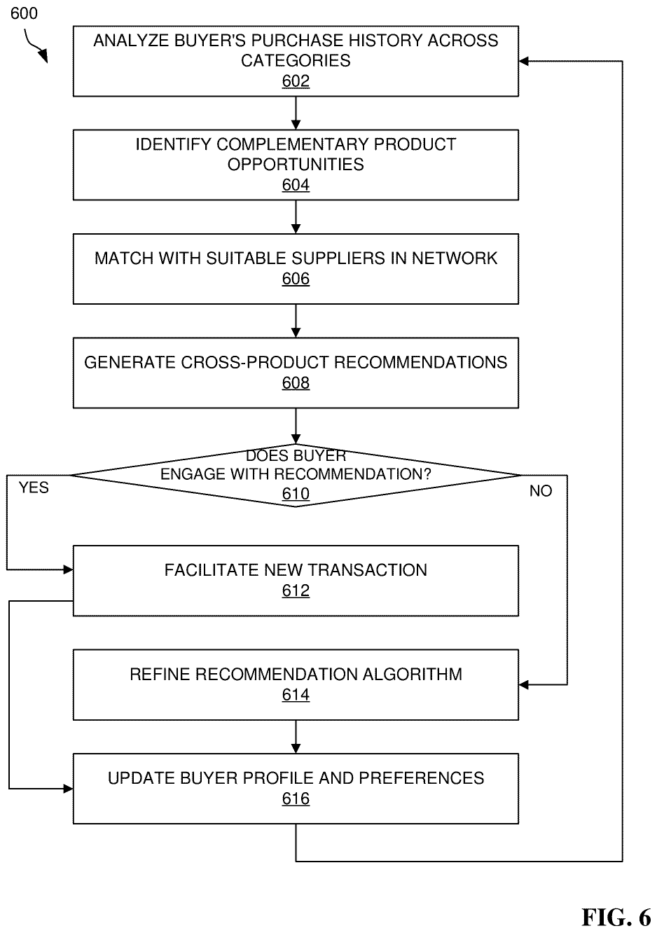

FIG. 6 illustrates a flowchart of a method 600 for buyer-supplier matching and recommendation optimization, in accordance with one embodiment. As an option, the method 600 may be implemented in the context of any one or more of the embodiments set forth in any previous and/or subsequent Figures and/or description thereof. Of course, however, the method 600 may be implemented in the context of any desired environment. Further, the aforementioned definitions may equally apply to the description below.

In step 602, a buyer's purchase history across categories is analyzed. The analysis may involve examining transaction records stored in the information database to identify patterns in the buyer's purchasing behavior. This analysis may extend to include not only direct purchases but also inquiries, abandoned cart items, and wishlist entries to provide a more comprehensive view of the buyer's interests. The system may also incorporate external data sources, such as industry reports and market trends, to contextualize the buyer's behavior within broader market dynamics. Further, the system may have the capability to analyze line items on draft invoices that are created but never sent, potentially providing insights into planned or considered purchases that may not be reflected in completed transaction data.

In some cases, the analysis may include categorizing purchases based on product types, frequency of orders, and average order values. The buyer module may utilize machine learning algorithms to detect trends and preferences in the buyer's historical data. These algorithms may employ techniques such as collaborative filtering, association rule mining, and sequence pattern mining to uncover hidden relationships between different product categories and buying behaviors. The system may also use natural language processing to analyze any textual feedback or reviews provided by the buyer, extracting sentiment and specific product feature preferences.

In step 604, identifying complementary product opportunities are identified based on the analyzed purchase history is executed. This step may involve using the adaptive model to recognize potential cross-selling or upselling opportunities. The adaptive model may utilize advanced techniques such as deep learning and reinforcement learning to continuously improve its ability to identify relevant complementary products. It may also incorporate real-time market data and inventory levels to ensure that recommended products are currently available and in demand.

The identification process may consider factors such as product compatibility, industry-specific bundling practices, and seasonal trends. In some cases, the system may also analyze successful complementary product pairings from similar buyers to inform its recommendations. The system may employ clustering algorithms to group buyers with similar purchasing patterns and use these clusters to generate more targeted and relevant complementary product suggestions. Additionally, the system may consider the buyer's past response to recommendations, including click-through rates and conversion rates, to refine its approach.

In step 606, suitable suppliers in the network are matched with the identified opportunities. The matching process may leverage data from the seller module to find suppliers capable of fulfilling the complementary product opportunities. This matching may take into account not only the supplier's product offerings but also their historical performance metrics, such as fulfillment rates, on-time delivery percentages, and customer satisfaction scores. The system may use a multi-criteria decision-making algorithm to balance these various factors and identify the most suitable suppliers.

The system may consider factors such as supplier capacity, product quality ratings, and geographical proximity when making matches. In some cases, the payment intelligence module may be utilized to assess the financial stability and reliability of potential supplier matches. This assessment may include analyzing the supplier's credit history, payment patterns to their own suppliers, and overall financial health. The system may also consider any existing relationships or previous successful transactions between the buyer and potential suppliers to prioritize matches that are likely to result in smooth transactions.

In step 608, cross-product recommendations are generated based on the matching results. These recommendations may be tailored to the specific buyer's needs and preferences, as determined by the earlier analysis. The system may employ advanced personalization algorithms that take into account not only the buyer's purchase history but also their browsing behavior, interaction with previous recommendations, and any explicitly stated preferences. The recommendations may be dynamically adjusted based on the buyer's current context, such as the time of day, device being used, or current location.

The recommendations may be presented through the vendor buyer hub, potentially utilizing features of the marketplace optimization module to prioritize and display the most relevant suggestions. In some cases, the system may provide additional context or rationale for each recommendation to help the buyer make informed decisions. This context may include social proof elements, such as reviews from similar buyers, or highlight specific features that align with the buyer's known preferences. The system may also employ A/B testing to continuously optimize the presentation and framing of recommendations to maximize engagement and conversion rates.

In decision 610, it is determined whether the buyer engages with the recommendation. This decision point allows the system to track the effectiveness of its recommendations and gather data for future refinement. The system may employ advanced tracking mechanisms to capture a wide range of engagement metrics, including hover time, scroll depth, and interaction with any interactive elements of the recommendation display.

The engagement may be measured through various actions, such as clicking on a recommendation, requesting more information, or initiating contact with a recommended supplier. In some cases, the system may also consider the time spent reviewing a recommendation as a form of engagement. The system may use machine learning algorithms to identify patterns in engagement behavior that are predictive of eventual purchases, allowing it to refine its definition of meaningful engagement over time. It may also analyze the sequence and timing of multiple engagements to understand the buyer's decision-making process and identify potential pain points or hesitations.

If the buyer engages with the recommendation (Yes branch), a step 612 of facilitating a new transaction is executed. This step may involve leveraging features of the vendor buyer hub to streamline the transaction process. The system may employ intelligent workflow automation to guide the buyer and supplier through each stage of the transaction, from initial inquiry to final payment. This automation may adapt based on the specific requirements of the product or service being transacted, as well as any known preferences of the buyer or supplier.

The facilitation may include actions such as initiating a secure communication channel between the buyer and supplier, generating a preliminary quote, or preparing a draft contract based on standard terms. In some cases, the payment intelligence module may be utilized to suggest optimal payment terms or financing options for the transaction. These suggestions may take into account factors such as the buyer's cash flow patterns, the supplier's preferred payment methods, and current market interest rates. The system may also offer escrow services or other trust-building mechanisms to facilitate smooth transactions between parties that have not previously done business together.

If the buyer does not engage with the recommendation (No branch), a step 614 of refining the recommendation algorithm based on the buyer's response is performed. This step ensures that the system continuously improves its ability to generate relevant and appealing recommendations. The refinement process may employ advanced machine learning techniques such as gradient boosting or neural network fine-tuning to incrementally improve the algorithm's performance. The system may also use techniques from the field of explainable AI to gain insights into why certain recommendations were successful or unsuccessful, allowing for more targeted improvements.

The refinement process may involve adjusting weightings in the adaptive model based on successful recommendations or identifying patterns in rejected suggestions. In some cases, the system may also analyze the timing and context of buyer engagements to optimize when and how recommendations are presented. This analysis may include factors such as the buyer's typical purchasing cycle, time of day preferences, or response to different types of promotional messaging. The system may also implement a multi-armed bandit approach to balance exploration of new recommendation strategies with exploitation of known successful approaches.

In step 616, the buyer profile and preferences are updated. This step ensures that the system maintains an up-to-date understanding of the buyer's needs and behaviors. The update process may employ sophisticated data integration techniques to merge new insights with existing profile information, resolving any conflicts or inconsistencies. The system may use probabilistic models to handle uncertainty in preference changes, allowing it to adapt gradually to shifts in buyer behavior while being resistant to temporary anomalies.

The update may include recording new product interests, adjusting category preferences based on recent engagements, and refining the buyer's price sensitivity profile. In some cases, the buyer data store may be updated with new information that can be used to inform future recommendations and matching processes. The system may employ techniques from the field of online learning to continuously update the buyer profile in real-time, ensuring that each interaction with the platform contributes to a more accurate and current understanding of the buyer's preferences. Additionally, the system may periodically prompt the buyer for explicit feedback or preference updates, using intelligently timed and contextually relevant queries to gather high-value information without causing undue friction in the user experience.

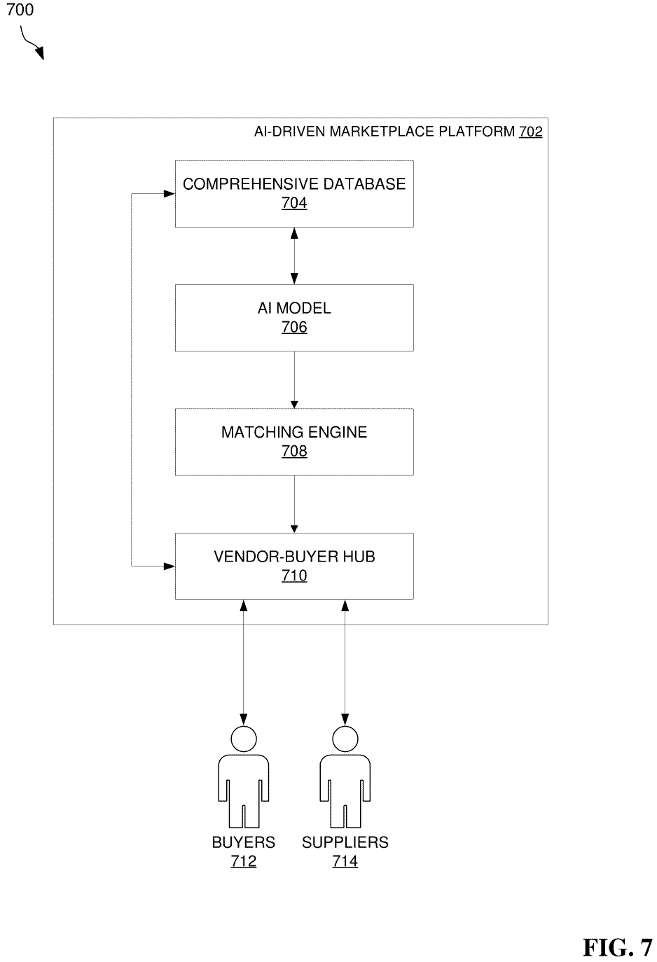

FIG. 7 illustrates a block diagram of a marketplace system 700, in accordance with one embodiment. As an option, the marketplace system 700 may be implemented in the context of any one or more of the embodiments set forth in any previous and/or subsequent Figures and/or description thereof. Of course, however, the marketplace system 700 may be implemented in the context of any desired environment. Further, the aforementioned definitions may equally apply to the description below.

The marketplace system 700 includes an AI-driven marketplace platform 702 that contains multiple interconnected components. The AI-driven marketplace platform 702 includes a comprehensive database 704 that stores data related to buyers and suppliers. This database may utilize advanced data structures such as distributed hash tables and graph databases to efficiently store and retrieve complex relational data. The platform may also implement a data lake architecture to accommodate both structured and unstructured data, allowing for flexible data ingestion and analysis.

In some cases, the comprehensive database 704 may contain information similar to that stored in the information database 206, including transactional history, risk profiles, and financial behavior across multiple product offerings. The comprehensive database 704 may be continuously updated with new data generated through interactions within the marketplace system 700. The database may employ real-time data streaming technologies like Apache Kafka to ensure low-latency updates and maintain data consistency across distributed systems. It may also create an immutable audit trail of all transactions and data modifications.

The AI-driven marketplace platform 702 also includes an AI model 706 that communicates bidirectionally with the comprehensive database 704. The AI model 706 may analyze the data stored in the comprehensive database 704 to generate insights and predictions about buyer and supplier behavior. This model may incorporate ensemble learning techniques, combining multiple algorithms such as random forests, gradient boosting machines, and neural networks to improve prediction accuracy and robustness.

In some cases, the AI model 706 may employ machine learning algorithms to identify patterns and trends in the data, similar to the functionality described for the adaptive model 210. The AI model 706 may continuously refine its predictive capabilities based on new data and feedback from marketplace interactions. The model may utilize online learning algorithms to adapt in real-time to changing market conditions and user behaviors. It may also implement federated learning techniques to leverage insights from decentralized data sources while maintaining data privacy.

The AI model 706 connects to a matching engine 708, which processes information from the AI model 706. The matching engine 708 may use the insights and predictions generated by the AI model 706 to create intelligent matching recommendations between buyers and suppliers. The matching engine may employ sophisticated optimization algorithms, such as constraint satisfaction solvers or genetic algorithms, to efficiently explore the vast space of possible buyer-supplier matches and identify optimal pairings.

In some cases, the matching engine 708 may consider factors such as product compatibility, pricing alignment, and risk profiles when generating recommendations. The matching engine 708 may also incorporate trust ratings and other metrics to enhance the quality of its recommendations. It may utilize multi-objective optimization techniques to balance multiple, potentially conflicting criteria when making matches. The engine may also implement a learning-to-rank approach, continuously refining its ranking algorithm based on user feedback and match outcomes.

A vendor-buyer hub 710 is provided within the AI-driven marketplace platform 702 and maintains bidirectional communication with both the comprehensive database 704 and external users. The vendor-buyer hub 710 interfaces with buyers 712 and suppliers 714, allowing these external users to interact with the marketplace system 700. The hub may feature a microservices architecture to ensure scalability and flexibility, with each key functionality encapsulated in independent, deployable services.

In some cases, the vendor-buyer hub 710 may offer features similar to those described for the vendor buyer hub 212, such as secure messaging, document sharing, and transaction processing. The vendor-buyer hub 710 may serve as the primary interface for buyers 712 and suppliers 714 to access the marketplace system 700. The hub may implement advanced security measures such as end-to-end encryption for all communications and multi-factor authentication for user access. It may also offer customizable dashboards and analytics tools, allowing users to gain insights into their marketplace activities and performance metrics.

The vendor-buyer hub 710 enables interactions between buyers 712 and suppliers 714 while maintaining connections to other components of the AI-driven marketplace platform 702. This interconnected structure allows for seamless data flow and real-time updates throughout the marketplace system 700. The hub may utilize event-driven architecture and publish-subscribe patterns to ensure efficient, real-time propagation of updates and notifications across the system. It may also implement caching mechanisms and content delivery networks to optimize performance and reduce latency for users across different geographical locations.

In some cases, the interactions facilitated by the vendor-buyer hub 710 may generate new data that is fed back into the comprehensive database 704. This data may then be used by the AI model 706 to further refine its predictions and improve the matching recommendations provided by the matching engine 708. The system may employ advanced data pipeline technologies to ensure efficient, reliable data ingestion and processing. It may also implement anomaly detection algorithms to identify unusual patterns or potential issues in the newly generated data, triggering alerts or automated responses as needed.

In some cases, the AI model 706 may be enhanced with natural language processing capabilities to analyze unstructured data from user communications and feedback. This enhancement may allow for more nuanced understanding of user preferences and behavior, leading to more accurate matching recommendations.

Additionally, the vendor-buyer hub 710 may be expanded to include collaborative features that allow buyers 712 and suppliers 714 to form strategic partnerships or joint ventures. These features may be supported by advanced analytics from the AI model 706, helping users identify synergistic opportunities within the marketplace ecosystem.

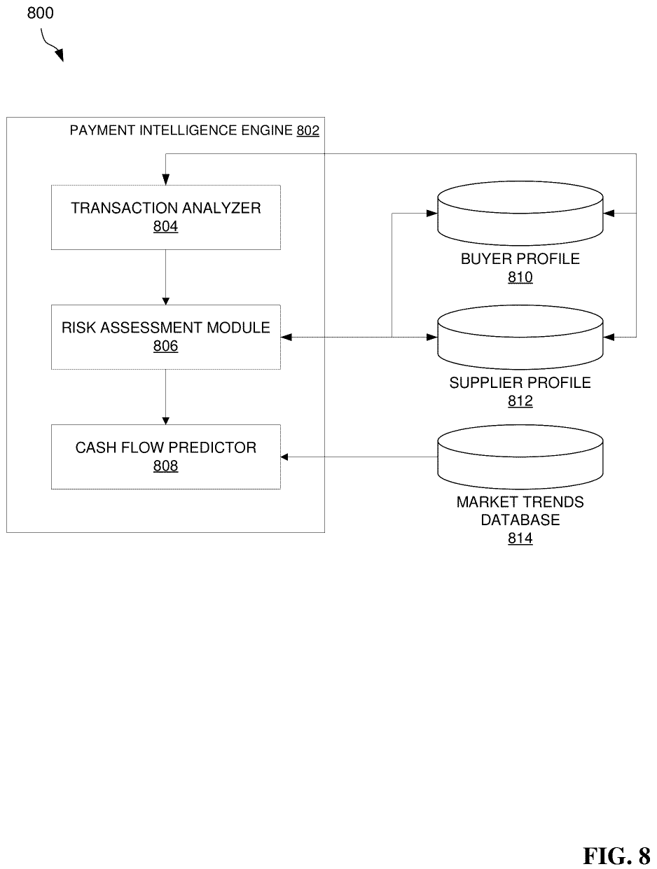

FIG. 8 illustrates a block diagram of a payment intelligence system 800, in accordance with one embodiment. As an option, the payment intelligence system 800 may be implemented in the context of any one or more of the embodiments set forth in any previous and/or subsequent Figures and/or description thereof. Of course, however, the payment intelligence system 800 may be implemented in the context of any desired environment. Further, the aforementioned definitions may equally apply to the description below.

The payment intelligence system 800 includes a payment intelligence engine 802 that processes and analyzes payment-related information. The payment intelligence engine 802 may be designed to enhance decision-making and risk assessment within the marketplace system by analyzing payment patterns, credit utilization, and cash flow cycles. The engine may employ advanced machine learning algorithms, such as recurrent neural networks and gradient boosting machines, to identify complex patterns in financial data. It may also utilize natural language processing techniques to extract relevant information from unstructured financial documents and reports.

In some cases, the payment intelligence engine 802 may integrate with the AI model, as discussed herein, to provide financial insights that improve the accuracy of buyer-supplier matching recommendations. The payment intelligence engine 802 may also communicate with the vendor buyer hub to offer real-time financial intelligence during transactions. This integration may allow for dynamic adjustment of credit terms or pricing based on real-time risk assessments. The engine may also provide automated alerts to marketplace participants when significant changes in financial conditions are detected.

The payment intelligence engine 802 contains a transaction analyzer 804, which processes transaction data from various sources within the marketplace system. The transaction analyzer 804 may examine factors such as payment frequency, transaction volumes, and payment methods used by buyers and suppliers. It may employ time series analysis techniques to identify seasonal patterns or trends in transaction behavior. The analyzer may also use anomaly detection algorithms to flag unusual transactions that could indicate fraud or financial distress.

In some cases, the transaction analyzer 804 may identify patterns in payment behavior, such as consistent early payments or frequent late payments. This information may be used to assess the financial reliability of marketplace participants and inform risk assessments. The analyzer may generate detailed payment behavior profiles for each participant, including metrics such as average days to pay, frequency of disputed transactions, and preferred payment methods. These profiles may be used to create customized financial recommendations for each marketplace participant.

The payment intelligence engine 802 also includes a risk assessment module 806, which evaluates risk factors associated with buyers and suppliers. The risk assessment module 806 may analyze data from multiple sources to generate comprehensive risk profiles for marketplace participants. It may utilize advanced statistical techniques such as Monte Carlo simulations to model potential risk scenarios and their probabilities. The module may also incorporate machine learning models trained on historical default data to predict the likelihood of future payment defaults.

In some cases, the risk assessment module 806 may consider factors such as payment history, credit scores, and industry-specific risk indicators. The risk assessment module 806 may also take into account external factors like economic conditions or regulatory changes that could impact financial risk. The module may employ sentiment analysis on news feeds and social media to gauge market sentiment and incorporate this information into risk assessments. It may also use network analysis techniques to evaluate the interconnectedness of supply chains and assess systemic risks.

A cash flow predictor 808 is another component of the payment intelligence engine 802. The cash flow predictor 808 generates cash flow predictions based on data from the risk assessment module 806 and information stored in a market trends database 814. The predictor may utilize advanced time series forecasting techniques such as ARIMA models or Prophet to generate accurate cash flow projections. It may also incorporate external factors such as planned marketing campaigns or anticipated market disruptions into its predictions.

In some cases, the cash flow predictor 808 may use machine learning algorithms to forecast future cash flow patterns for buyers and suppliers. These predictions may help marketplace participants make informed decisions about payment terms, credit limits, and financial planning. The predictor may offer scenario analysis tools that allow users to model the impact of different business decisions on their future cash flows. It may also provide confidence intervals for its predictions, helping users understand the range of potential outcomes.

The payment intelligence system 800 includes a buyer profile database 810 and a supplier profile database 812, which store respective profile information that is accessed by the risk assessment module 806 and/or the transaction analyzer 804. These databases may contain detailed financial histories, credit information, and transaction records for buyers and suppliers. The databases may utilize advanced data structures such as graph databases to efficiently store and query complex relational data. They may also implement data versioning to maintain a historical record of profile changes over time.

In some cases, the buyer profile database 810 and supplier profile database 812 may be continuously updated with new data generated through marketplace transactions. This real-time updating may ensure that risk assessments and financial predictions remain current and accurate. The databases may employ stream processing technologies to handle high-volume, real-time data updates. They may also use data quality checks and anomaly detection algorithms to ensure the integrity and reliability of incoming data.

The market trends database 814 contains market trend information that is utilized by the cash flow predictor 808. This database may store data on industry-specific financial trends, economic indicators, and historical market performance. It may employ time series databases optimized for storing and querying time-stamped data. The database may also implement data compression techniques to efficiently store large volumes of historical trend data.

In some cases, the market trends database 814 may incorporate data from external sources to provide a comprehensive view of market conditions. This information may be used to contextualize cash flow predictions and improve their accuracy across different industries and market segments. The database may utilize APIs to automatically ingest data from trusted external sources such as government economic databases or industry-specific data providers. It may also employ natural language processing techniques to extract relevant trend information from news articles and financial reports.

The payment intelligence engine 802 coordinates the flow of information between the transaction analyzer 804, risk assessment module 806, and cash flow predictor 808, while managing interactions with the buyer profile database 810, supplier profile database 812, and market trends database 814. This coordinated approach ensures that all components of the payment intelligence system 800 work together to provide comprehensive financial intelligence. The engine may employ a microservices architecture to allow for independent scaling and updating of each component. It may also utilize advanced orchestration tools to manage the complex workflows between different components.

In some cases, the payment intelligence engine 802 may employ advanced data encryption and security protocols to protect sensitive financial information. These security measures may help maintain trust and confidentiality within the marketplace ecosystem. The engine may implement end-to-end encryption for all data transmissions and use secure enclaves for processing sensitive financial data. It may also create an immutable audit trail of all financial transactions and risk assessments, further enhancing trust and transparency in the system.

In various embodiments, the payment intelligence system 800 may be extended to include machine learning algorithms that can identify complex patterns in financial behavior. These algorithms may be trained on historical transaction data to detect early warning signs of financial distress or opportunities for optimizing payment strategies. Additionally, the payment intelligence system 800 may be adapted to support industry-specific financial metrics and risk factors. This specialization may allow for more nuanced and relevant financial assessments in sectors with unique financial characteristics or regulatory requirements. Further, the payment intelligence system 800 may be enhanced to include a recommendation engine that suggests optimal payment terms or financing options based on the analyzed financial data. This feature may help facilitate smoother transactions and improve overall financial health within the marketplace ecosystem.

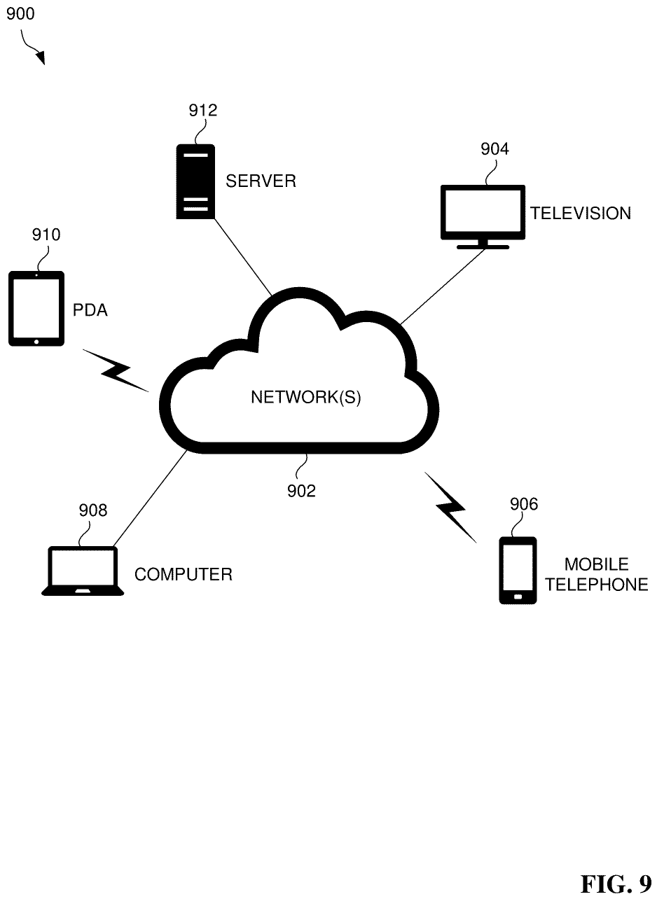

FIG. 9 illustrates a network system 900 for facilitating communication between various devices, in accordance with one embodiment. As an option, the network system 900 may be implemented in the context of any one or more of the embodiments set forth in any previous and/or subsequent Figures and/or description thereof. Of course, however, the network system 900 may be implemented in the context of any desired environment. Further, the aforementioned definitions may equally apply to the description below.

The network system 900 includes a communication network 902 that connects multiple devices including a television device 904, a mobile telephone device 906, a computer device 908, a personal digital assistant 910, and a server device 912. The communication network 902 may be represented as a cloud-based network structure that enables data exchange between the connected devices. In some cases, the communication network 902 may utilize various protocols and technologies to facilitate communication, such as TCP/IP, HTTP, or wireless protocols like Wi-Fi or cellular data networks.

The server device 912 may connect to the communication network 902 and process and manage data communications between the other devices in the network system 900. In some cases, the server device 912 may host applications or services that are accessed by the other connected devices, such as the marketplace system described in previous figures. The television device 904 may connect to the communication network 902, allowing the television device 904 to receive and display content. In some cases, the television device 904 may be a smart TV capable of running applications that interact with the marketplace system or other services provided through the network system 900.

The mobile telephone device 906 and personal digital assistant 910 may connect wirelessly to the communication network 902, as indicated by the lightning bolt symbols. These mobile devices may provide users with on-the-go access to the marketplace system, allowing buyers and suppliers to interact with the platform from various locations. The computer device 908 may maintain a connection to the communication network 902, enabling data transfer and communication with other devices in the network system 900. In some cases, the computer device 908 may be used by buyers or suppliers to access the vendor buyer hub and engage in marketplace activities.

The network system 900 may employ a distributed topology where each device connects to the central communication network 902, allowing for data exchange and communication between any of the connected devices through the network infrastructure. This distributed approach may enable efficient information sharing and collaboration within the marketplace ecosystem. In some cases, the network system 900 may incorporate security measures to protect sensitive data transmitted between devices. These security measures may include encryption protocols, firewalls, and authentication mechanisms to ensure the integrity and confidentiality of marketplace transactions and user information.

In various embodiments, the network system 900 may be extended to include Internet of Things (IoT) devices that can provide real-time data relevant to marketplace transactions. For example, connected sensors in warehouses or manufacturing facilities may automatically update inventory levels or production capacities, enhancing the accuracy of supplier information in the marketplace system.

In some cases, the network system 900 may be adapted to support edge computing capabilities, where certain processing tasks are performed on local devices rather than centralized servers. This approach may reduce latency and improve response times for time-sensitive marketplace steps, such as real-time bidding or instant messaging between buyers and suppliers.

Additionally, the network system 900 may be enhanced to include augmented reality (AR) or virtual reality (VR) capabilities, allowing users to visualize products or conduct virtual meetings through compatible devices. These immersive technologies may provide new ways for buyers and suppliers to interact and evaluate potential business opportunities within the marketplace ecosystem.

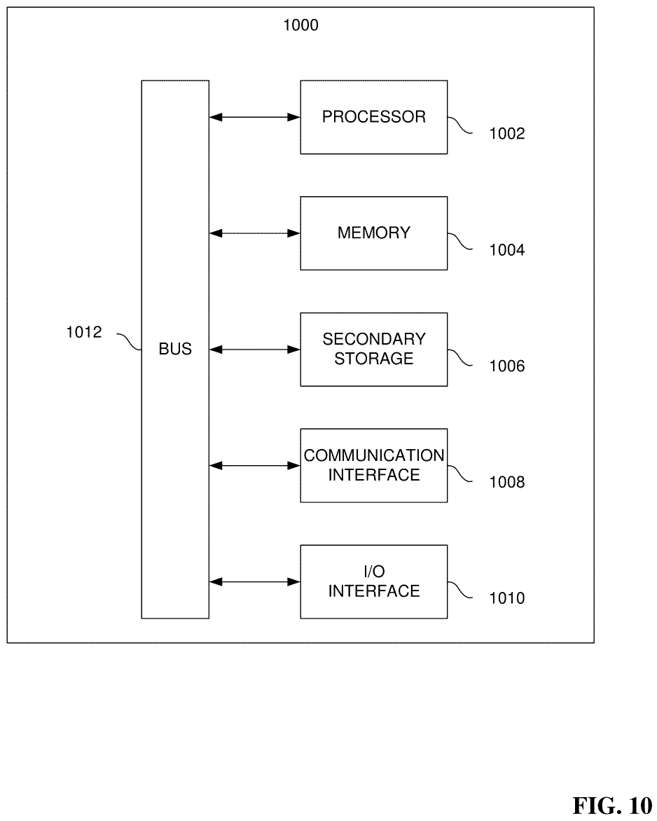

FIG. 10 illustrates a block diagram of a computing system 1000, in accordance with one embodiment. As an option, the computing system 1000 may be implemented in the context of any one or more of the embodiments set forth in any previous and/or subsequent Figures and/or description thereof. Of course, however, the computing system 1000 may be implemented in the context of any desired environment. Further, the aforementioned definitions may equally apply to the description below.

The computing system 1000 includes a processor 1002, memory 1004, secondary storage 1006, a communication interface 1008, and an input/output interface 1010, all interconnected via a system bus 1012. The processor 1002 connects to the system bus 1012 and processes instructions and data for the computing system 1000, potentially executing software programs stored in the memory 1004 or secondary storage 1006. The memory 1004 couples to the system bus 1012 and stores data and instructions for use by the processor 1002, including volatile memory components like RAM and non-volatile components like ROM.

The secondary storage 1006 connects to the system bus 1012 and provides additional data storage capacity, potentially including long-term storage devices such as hard disk drives, solid-state drives, or optical disk drives. The communication interface 1008 couples to the system bus 1012 and enables communication between the computing system 1000 and external devices or networks, potentially including network adapters or wireless transceivers to connect to the communication network 902. The input/output interface 1010 connects to the system bus 1012 and facilitates interaction with external input/output devices like keyboards, mice, displays, or printers.

The system bus 1012 provides a communication pathway for data transfer between all components within the computing system 1000, potentially using various protocols and architectures for efficient data transmission. The computing system 1000 may be utilized to implement various components of the marketplace system 700, such as the AI-driven marketplace platform 702 or the vendor-buyer hub 710, with the processor 1002 potentially executing algorithms associated with the AI model 706, and the memory 1004 and secondary storage 1006 storing data from the comprehensive database 704.

The communication interface 1008 may facilitate interactions between the computing system 1000 and external devices used by buyers 712 and suppliers 714, such as the mobile telephone device 906 or computer device 908, while the input/output interface 1010 may support user interactions with the marketplace system 700 through various input and display devices.

In various embodiments, the computing system 1000 may be extended to include specialized hardware accelerators for machine learning steps. These accelerators may enhance the performance of the AI model 706, allowing for faster processing of complex algorithms used in buyer-supplier matching and market trend analysis.

In some cases, the computing system 1000 may be adapted to support distributed computing architectures, where multiple instances of the system work together to handle increased workloads. This scalable approach may allow the marketplace system 700 to accommodate growing numbers of users and transactions without compromising performance.

Additionally, the computing system 1000 may be enhanced to include advanced data encryption and anonymization capabilities at the hardware level. These features may help ensure that personal data is anonymized and aggregated according to compliance needs, addressing privacy concerns in the marketplace system 700. The enhanced security measures may be implemented across various components, including the processor 1002, memory 1004, and communication interface 1008, to provide comprehensive protection for sensitive user information.

By way of a use-case scenario, and in various embodiments, a medium-sized manufacturing company implements the AI-driven buyer-supplier matching and marketplace optimization system to streamline its procurement processes. The company's purchasing manager, Sarah, logs into the vendor-buyer hub using her mobile device to source a new supplier for specialized electronic components. The AI model analyzes Sarah's company's historical purchase data, financial behavior, and current market trends to generate a list of recommended suppliers. Each recommendation includes a trust rating based on the supplier's transaction history and risk profile. Sarah reviews the top-rated suppliers and selects one for further engagement. Through the secure communication channel within the hub, she initiates a negotiation process with the chosen supplier. The payment intelligence engine provides real-time insights on optimal payment terms based on both parties' financial data. As Sarah and the supplier agree on terms, the system automatically generates a smart contract. Once the transaction is complete, the system updates its database with the new interaction data, refining its predictive capabilities for future recommendations. This streamlined process allows Sarah's company to find a reliable supplier quickly, negotiate favorable terms, and contribute to the continuous improvement of the marketplace ecosystem.

The present disclosure addresses significant challenges in business-to-business (B2B) marketplace systems that have long plagued existing solutions. Prior art systems have struggled to efficiently connect buyers with suitable suppliers while optimizing marketplace interactions, particularly in scenarios involving complex supply chains and vast numbers of potential business partners. These conventional systems often face limitations such as limited access to comprehensive data about buyer and supplier behaviors, difficulties in accurately assessing the reliability and trustworthiness of potential business partners, and the inability to provide personalized recommendations based on a company's specific needs and transaction history. As a result, they frequently fail to provide timely and accurate recommendations that take into account factors such as supplier capacity, financial stability, and past performance, leading to suboptimal matching and missed opportunities for both buyers and suppliers.

The disclosed system overcomes these deficiencies through a novel approach that leverages comprehensive two-sided data, including transactional history, risk profiling, and financial behavior across multiple products, to provide intelligent recommendations and matchmaking services. By incorporating an AI model that continuously learns from user interactions to refine its predictive capabilities over time, as well as a Payment Intelligence Engine to enhance decision-making and risk assessment, the system achieves a level of marketplace optimization previously unattainable. Furthermore, the establishment of an independent vendor-buyer Hub for connections and transactions generates additional data to continually improve offerings, addressing a critical pain point in existing solutions. This innovative approach not only enhances the accuracy and relevance of buyer-supplier matching but also leads to more efficient procurement processes, improved risk management, and increased trust within the marketplace ecosystem, effectively resolving the longstanding issues of limited data access and static recommendation systems that have plagued prior art B2B marketplace platforms.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of steps that are performed by one or more devices, unless indicated otherwise. As such, it will be understood that such acts and steps, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and steps described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A computer program product for facilitating AI-driven buyer-supplier matching and marketplace optimization, the computer program product comprising a computer readable storage medium having program instructions embodied therewith, the program instructions executable by a processor to cause the processor to:
store comprehensive behavioral data for a plurality of buyers and suppliers in a database;
analyze the stored behavioral data, using an adaptive artificial intelligence (AI) model, to generate buyer and supplier intelligence;
integrate a payment intelligence engine with the AI model to enhance decision-making and risk assessment;
provide intelligent matching recommendations between buyers and suppliers based on: 1) the generated buyer and supplier intelligence and 2) data from the payment intelligence engine;
provide an independent vendor-buyer hub that is configured to display the intelligent matching recommendations and provide direct interactions and transactions;
collect new behavioral data based on at least one interaction or transaction of the independent vendor-buyer hub; and
continuously update the database and refine the AI model's predictive capabilities based on the new behavioral data.

2. The computer program product of claim 1, wherein the comprehensive behavioral data includes transactional history, risk profiling data, and financial behavior data across multiple product offerings.

3. The computer program product of claim 2, wherein the program instructions are further executable by the processor to cause the processor to:
generate trust ratings for buyers and suppliers based on their behavioral data and transaction history; and
incorporate the trust ratings into the matching recommendations provided by the AI model.

4. The computer program product of claim 3, wherein the program instructions are further executable by the processor to cause the processor to flag entities with trust ratings below a predetermined threshold for further review or exclusion from matching recommendations.

5. The computer program product of claim 1, wherein the AI model comprises:
a machine learning algorithm that continuously learns from user interactions;
a natural language processing component for analyzing textual data in user profiles and communications; and
a predictive analytics module for forecasting future buyer needs and supplier capabilities.

6. The computer program product of claim 5, wherein the program instructions are further executable by the processor to cause the processor to utilize collaborative filtering techniques to identify non-obvious product connections and expand the range of relevant recommendations.

7. The computer program product of claim 1, wherein the independent vendor-buyer hub comprises:
a secure communication channel for direct buyer-supplier negotiations;
a smart contract system for automating agreement terms and conditions; and
a dispute resolution mechanism integrated with the AI model for suggesting fair resolutions based on historical data and transaction patterns.

8. The computer program product of claim 7, wherein the program instructions are further executable by the processor to cause the processor to provide a decentralized and tamper-resistant record of transactions and agreements within the vendor-buyer hub.

9. The computer program product of claim 1, wherein the payment intelligence engine is configured to:
analyze payment patterns, credit utilization, and cash flow cycles;
generate risk assessments for buyers and suppliers; and
provide tailored financial recommendations based on the analyzed data.

10. The computer program product of claim 9, wherein the program instructions are further executable by the processor to cause the processor to integrate real-time market data and economic indicators into the payment intelligence engine to enhance the accuracy of financial recommendations and risk assessments.

11. The computer program product of claim 1, wherein the program instructions are further executable by the processor to cause the processor to implement a dynamic supplier capacity modeling system that estimates supplier capacity based on historical transaction data, seasonal trends, and real-time order volumes.

12. The computer program product of claim 11, wherein the program instructions are further executable by the processor to cause the processor to utilize the dynamic supplier capacity modeling system to provide buyers with real-time availability information and lead time estimates for potential suppliers.

13. The computer program product of claim 1, wherein the program instructions are further executable by the processor to cause the processor to generate and implement an adaptive pricing algorithm that considers factors including supply chain disruptions, raw material costs, and competitor pricing to suggest optimal pricing strategies for suppliers.

14. The computer program product of claim 13, wherein the program instructions are further executable by the processor to cause the processor to provide buyers with price trend forecasts and optimal purchase timing recommendations based on the adaptive pricing algorithm and historical transaction data.

15. The computer program product of claim 1, wherein the program instructions are further executable by the processor to cause the processor to implement a cross-product recommendation system that analyzes buyer behavior across multiple product categories to suggest complementary or alternative products from different suppliers.

16. The computer program product of claim 15, wherein the program instructions are further executable by the processor to cause the processor to utilize the cross-product recommendation system to identify potential bundling opportunities and suggest optimized product packages to both buyers and suppliers.

17. The computer program product of claim 1, wherein the program instructions are further executable by the processor to cause the processor to integrate Internet of Things (IoT) devices to provide real-time data on inventory levels, production capacities, and logistics information, enhancing the accuracy of supplier information and matching recommendations.

18. The computer program product of claim 17, wherein the program instructions are further executable by the processor to cause the processor to implement edge computing capabilities to process time-sensitive data from IoT devices locally, reducing latency and improving response times for real-time bidding and instant messaging between buyers and suppliers.

19. A method, comprising:
at a computer system:
storing comprehensive behavioral data for a plurality of buyers and suppliers in a database;
analyzing the stored behavioral data, using an AI model, to generate buyer and supplier intelligence;
integrating a payment intelligence engine with the AI model to enhance decision-making and risk assessment;
providing intelligent matching recommendations between buyers and suppliers based on: 1) the generated buyer and supplier intelligence and 2) data from the payment intelligence engine;
providing an independent vendor-buyer hub that is configured to display the intelligent matching recommendations and provide direct interactions and transactions;
collecting new behavioral data based on at least one interaction or transaction of the independent vendor-buyer hub; and
continuously updating the database and refining the AI model's predictive capabilities based on the new behavioral data.

20. A system, comprising:
a non-transitory memory storing instructions; and
one or more processors in communication with the non-transitory memory that execute the instructions to:
store comprehensive behavioral data for a plurality of buyers and suppliers in a database;
analyze the stored behavioral data, using an AI model, to generate buyer and supplier intelligence;
integrate a payment intelligence engine with the AI model to enhance decision-making and risk assessment;
provide intelligent matching recommendations between buyers and suppliers based on: 1) the generated buyer and supplier intelligence and 2) data from the payment intelligence engine;
provide an independent vendor-buyer hub that is configured to display the intelligent matching recommendations and provide direct interactions and transactions;
collect new behavioral data based on at least one interaction or transaction of the independent vendor-buyer hub; and
continuously update the database and refine the AI model's predictive capabilities based on the new behavioral data.
